(19) United States
(12) Patent Application Publication
(10) Pub. No.: US 2025/0345803 A1
(43) Pub. Date: Nov. 13, 2025

(54) Optimizing Rotating Mills Via Stress Monitoring

(71) Applicants: Jarek Rosinski, Newcastle (GB); Cory Waxman, Phoenix, AZ (US)

(72) Inventors: Jarek Rosinski, Newcastle (GB); Cory Waxman, Phoenix, AZ (US)

(21) Appl. No.: 19/200,002

(22) Filed: May 6, 2025

Related U.S. Application Data
(60) Provisional application No. 63/643,638, filed on May 7, 2024.

(51) Int. Cl. B02C 17/18

(52) U.S. Cl. CPC B02C 17/1805

(57) ABSTRACT

This invention is incorporated in a system for monitoring and optimizing the operation of rotating mills in industrial mining operations. The system provides real-time feedback on the internal state of the drum, which enables operators to maximize efficiency, reduce energy consumption, and minimize downtime, leading to significant economic and environmental benefits.

### FIELD OF INVENTION

This invention relates generally to the field of industrial rotating mills, and in particular to optimizing efficiency and reducing down-time of industrial rotating mills.

### BACKGROUND OF THE INVENTION

Rotating mills are used in grinding operations of various ores. For example, in Semi-Autogenous Grinding (SAG) mills, a rotating drum tumbles, lifts and releases steel balls in a cascading motion to impact and break up larger rocks. This attrition between grinding balls and ore particles causes grinding of finer particles. In self-grinding mills, larger rocks of ore cause impact breakage of other rocks and compressive grinding of finer particles. This grinding action is generally aided by slurries of grinding liquids. The inside of the mill drum is lined with lifting plates to lift the ore, slurry and balls inside the mill.

The mining industry currently uses variables such as rate of rotation, charge level, water/charge ratio, grinding media (e.g., steel balls)/charge ratio, size of openings, recirculation ratio, and feed rate to optimize the mill. Other inputs like RPM, vibration, shock in certain positions, sound, and bearing loads are also used to optimize the mill. However, these variables and inputs are not sufficient to provide load distribution around the circumference of the mill as a function of axial position.

Problems include:
Blind Operation: existing mills operate without real-time feedback on the internal state of the drum, making it difficult to determine the optimal level of ore charge and rotation speed.
Incorrect Fill: Overfilling or underfilling the drum can lead to inefficient crushing and energy waste.
Downtime Costs: Stopping the mill for inspection or adjustments incurs significant downtime costs.
Liner Wear: The constant impact of ore and grinding media on the inner lining of the drum leads to wear and tear, requiring costly replacements.

What is needed is a way to monitor and optimize the milling process in real-time.

### SUMMARY OF THE INVENTION

The present invention addresses these challenges by providing a system for monitoring and optimizing the milling process in real-time. Real-time feedback on the internal state of the drum enables operators to make informed decisions that can maximize efficiency, reduce energy consumption, and minimize downtime, all of which lead to economic and environmental benefits.

This present invention achieves these results by:
Strain Gauges: Installing a series of strain gauges along the axial length of the outer shell of the rotating drum to measure the strain on the shell caused by the weight and movement of the ore inside.
Accelerometers: Employing accelerometers (or other means of determining angular position) that provide information on the drum's rotational position and the dynamic accelerations due to forces acting on the inner shell.
Data Analysis: Analyzing the strain and acceleration data to determine key parameters including the level of ore charge within the drum, the point at which the ore detaches and falls within the drum during rotation, and the distribution of ore along the inside perimeter of the drum. An axial map of the charge level can also be utilized.

Some of the benefits of the present invention include:
Optimized Operation: Real-time feedback allows operators to adjust the ore charge, rotation speed, ball/charge ratio, recirculation ratio, and other parameters to achieve optimal crushing efficiency.
Reduced Energy Consumption: By optimizing the process, energy consumption is minimized, leading to cost savings and environmental benefits.
Minimized Downtime: The system enables proactive maintenance and adjustments, reducing costly downtime and maximizing production uptime.
Extended Liner Life: By preventing under/overfilling and optimizing the crushing process, wear and tear on the inner lining of the drum is managed, extending its lifespan and maximizing process output.

### DESCRIPTION OF DRAWINGS

A clear understanding of the key features of the invention summarized above are referenced to the appended drawings that illustrate the method and system of the invention. It will be understood that such drawings depict preferred embodiments of the invention and, therefore, are not to be considered as limiting its scope regarding other embodiments that the invention is capable of contemplating. Accordingly:

FIG. 1 illustrates a perspective view of typical rotating drum used in the mining industry; the rotating drum has strain gauges and data loggers positioned on the outside face of the drum;

FIG. 2 illustrates a side perspective view of typical rotating drum used in the mining industry; the rotating drum has strain gauges and data loggers positioned on the outside face of the drum;

FIG. 3 illustrates a one-dimensional strain gauge;

FIG. 4 illustrates a rosette-style strain gauge;

FIG. 5 illustrates a data logger, a one-dimensional strain gauge, and a connector.

FIG. 6 is an example of a graph showing strain (from a single element gauge) on the vertical axis and rotation of the drum on the horizontal axis.

FIG. 7 is an example of a graph showing strain (from a rosette-style gauge) on the vertical axis and rotation of the drum on the horizontal axis.

FIG. 8 is a close up view of FIG. 6. It illustrates the magnitude 60 of the strain and the rotational distance 62 that the ore is pressing against the inside of the drum.

FIGS. 9-11 illustrate various conditions inside the rotating drum.

### DETAILED DESCRIPTION

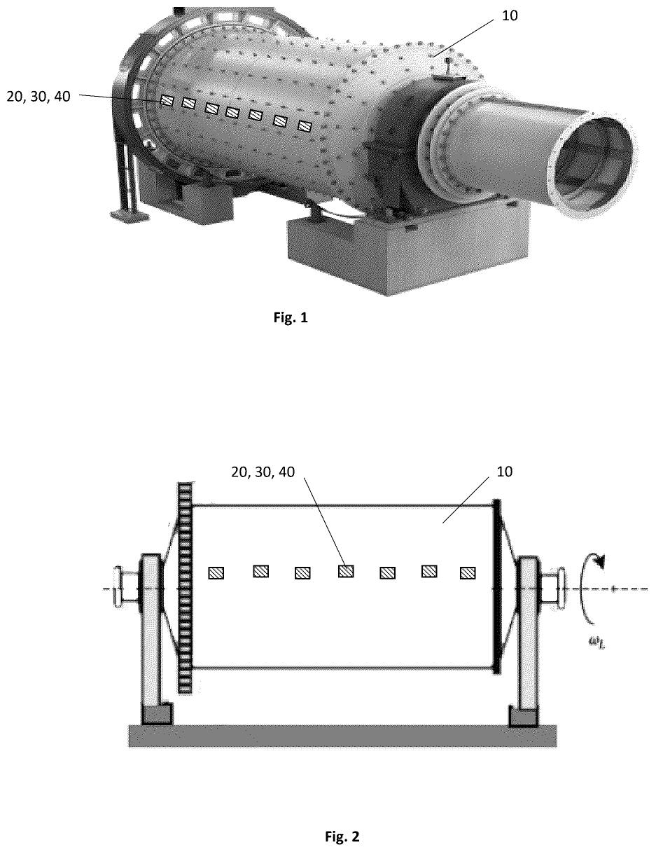

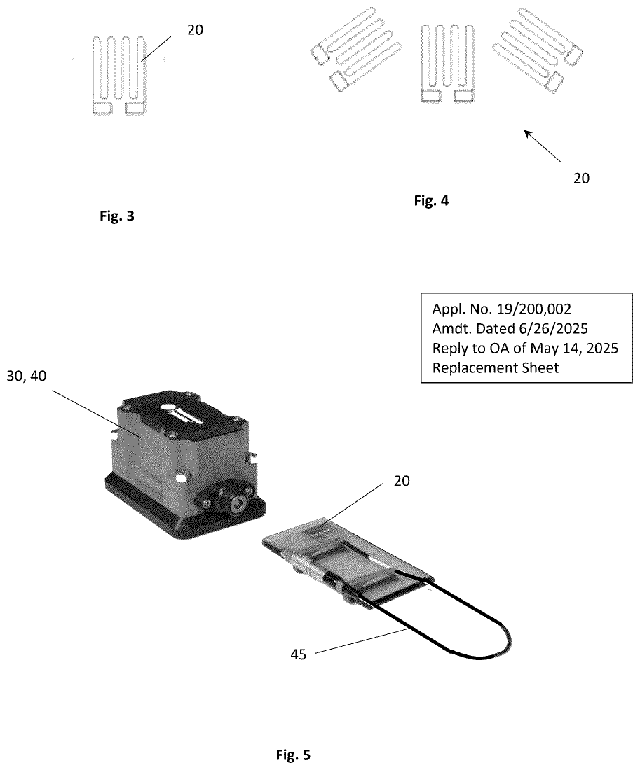

The invention is embodied in a system for optimizing a rotating mill. Turning to FIGS. 1 and 2, the preferred system comprises a rotatable drum 10, a plurality of strain gauges mounted on the outer surface of the drum 20, and a plurality of accelerometers 30 mounted to the outer surface of the drum.

While even a single strain gauge can provide valuable information and help optimize a rotating drum, it is preferred to use a plurality of strain gauges mounted along the drum's axial length as shown in FIGS. 1 and 2. A single axial line of gauges is sufficient, but additional lines could provide further insight into the 3D distribution of the ore. The spacing and number of strain gauges can vary depending on the circumstances. For example, it is presently preferred to use seven evenly-spaced strain gauges spaces on a rotating mill with an axial length of fifteen feet.

With respect to the strain gauge itself, it is preferred to use a rosette-style strain gauge. For the purposes of this specification, a “rosette-style strain gauge” means a strain gauge that measures strain in three directions, for example at 0°, 45°, and −45° angles, allowing for the calculation of principal strains and their directions. See, FIG. 4. However, a one-dimensional or a two-dimensional strain gauge would also suffice and provide valuable information and help optimize a rotating drum.

It is preferred to mount the strain gauges directly on the outside face of the rotatable drum in the ordinary fashion using an adhesive. It is also preferred to orient at least one strain gauge in an equatorial (or circumferential) direction.

The preferred accelerometer 30 is a DC accelerometer. Unlike AC accelerometers that measure vibrations and dynamic changes, DC accelerometers detect constant acceleration, like the one caused by gravity. This means a DC accelerometer can measure steady, unchanging accelerations, such as caused by the constant pull of gravity. Gravity constantly pulls objects towards the Earth's center at a rate of 1 G (approximately 9.8 m/s²). A DC accelerometer can measure this gravitational acceleration depending on its orientation relative to the Earth. For example, when the accelerometer points upwards (at 12:00 on a clock), it measures the full Earth of gravity, showing a reading of 1 G. If it's turned sideways (at 3:00 or 9:00), it's parallel to the Earth's surface and doesn't measure gravity's pull directly, resulting in a 0 G reading. If it is upside down (at 6:00) it measures gravity in the opposite direction, giving a reading of −1 G. As a result, by measuring the strength and direction of acceleration due to gravity, one can determine the exact orientation of the device to which the accelerometer is attached. It is like having a built-in compass that indicates which way is up. This information is very helpful for optimizing rotation mills.

A DC accelerometer can track both static and dynamic acceleration, which is helpful to determine the rotational position of the drum. Other non-DC accelerometers can track other things like vibration. Tracking vibration can also be helpful in process optimization but is not discussed here.

In addition to a strain gauge and an accelerometer, it is also preferred to use a data logger. For the purposes of this specification, a “data logger” is an electronic device that records data over time. The preferred data logger comprises a processor, a memory, data storage, one or more sensors, and a wireless transmitter. The preferred data logger is mounted to the outside surface of the rotatable drum and connected to one or more strain gauges. It is preferred to pair one data logger per strain gauge, but that is not required. A data logger could be connected to one, some, or all of the strain gauges.

It is preferred that the data logger 40 incorporate the DC accelerometer, but that is not required. The DC accelerometer and data logger could be separate elements. In addition to an accelerometer, the data logger could also comprise (or be connected) to other sensors for tracking things like vibration, noise, temperature, bolt tension and wear.

While it is preferred that the data logger 40 comprise a processor and memory to calculate information and transmit that information wirelessly, the data logger 40 could simply transmit the data to a remote processor and remote memory to perform calculations on the data.

Regardless of where the data is analyzed (by the data logger itself or remotely), the preferred calculations include calculating stress and rotational location of the rotatable drum. As discussed in more detail below, analyzing the strain and acceleration data can be used, for example, to determine the level of ore charge within the drum, adjust the ore charge, and adjust the rotation speed of the drum.

It is also preferred to implement machine learning to analyze the data. In this way, machine learning can implement algorithms to analyze data and suggest optimal operating parameters automatically.

### Preferred Optimizing Process

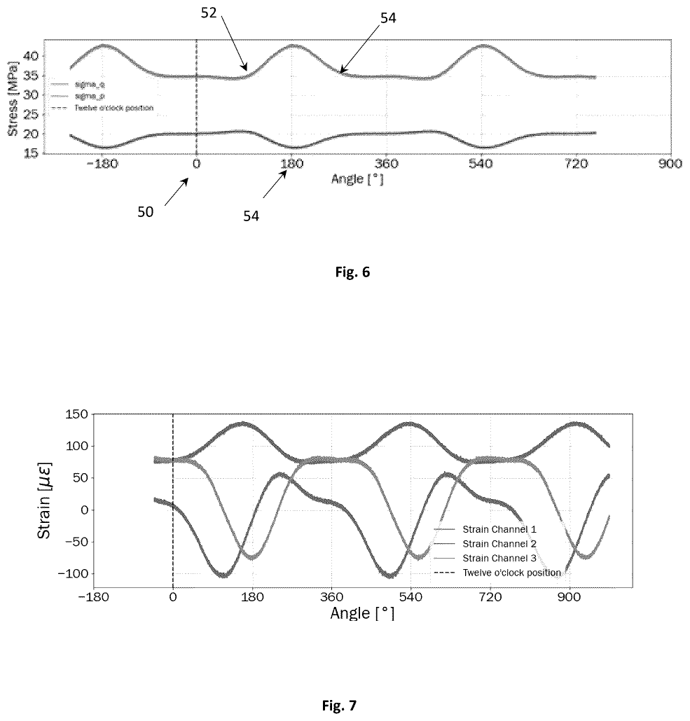

As the drum rotates, the strain gauges measure strain and the accelerometers track dynamic acceleration and provide positional information using the DC component of acceleration. The data can be placed on a two-dimensional graph. FIG. 6 is an example of a graph showing strain (from a single element gauge) on the vertical axis and rotation of the drum on the horizontal axis. FIG. 7 is an example of a graph showing strain (from a rosette-style gauge) on the vertical axis and rotation of the drum on the horizontal axis. The magnitude of strain indicates the load on the drum at different rotational positions. The presence and absence of strain indicate the location of the ore within the drum.

As the drum rotates, the ore inside shifts due to gravity, causing varying loads on the drum's shell at different positions. For example, at the 12 o'clock position (angle 0 degrees, element 50 on FIG. 6), when the drum is at the top, the strain on the shell is relatively constant because no ore is pressing on the shell directly. As the drum rotates, the ore starts falling and applying pressure on the shell, leading to increased strain. See, element 52. In this case it begins around the 4 o'clock position and the maximum strain likely occurs at the 6 o'clock position (bottom or 180 degrees) due to the weight of the ore. See, element 54. As the drum rotates further upwards (8 o'clock to 11 o'clock positions), the ore starts detaching and falling away, resulting in decreased strain on the shell. See element 54.

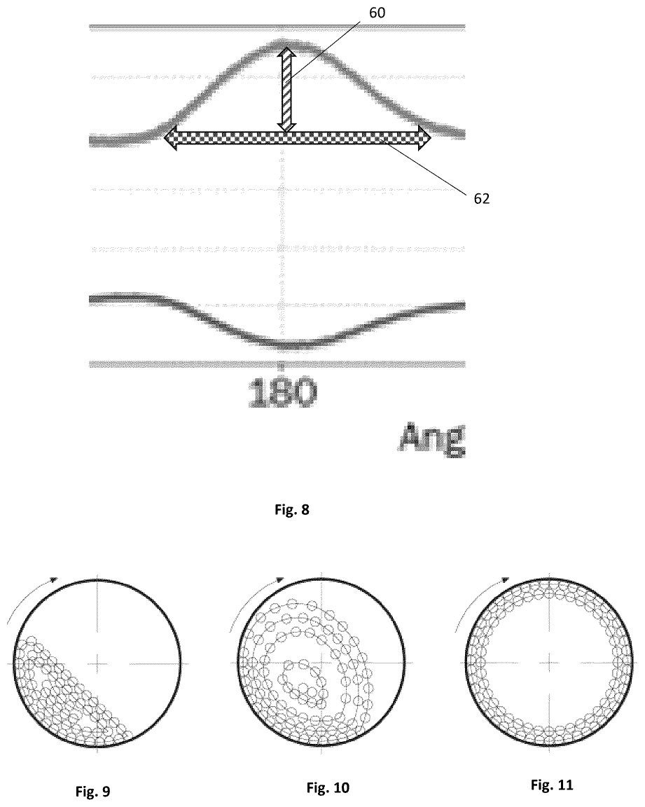

The point where the ore detaches and falls within the drum can be determined by noting where the magnitude of the strain reduces. FIG. 8 is a close up view of FIG. 6. It illustrates the magnitude 60 of the strain and the rotational distance 62 that the ore is pressing against the inside of the drum. This curve can be used to optimize the mill. If the magnitude 60 is not optimal, several options exist including (a) reducing the ore charge, (b) adjusting the drum rotation rate, (c) adjusting the water level or (d) other operational or controlled parameters. Similarly, if the rotational distance 62 is not optimal (meaning that the ore is pressing against the inside of the drum for too long), options exist including (a) reducing the ore charge, (b) adjusting the drum rotation rate, (c) adjusting the water level, or (d) other operational or controlled parameters.

By analyzing the strain measurements throughout a full rotation, it's possible to determine the positions where the ore detaches and falls within the drum. Multiple strain gauges placed along the axial length of the drum can provide a comprehensive picture of load distribution. This data can help optimize the milling process by adjusting factors like: (a) determining the optimal amount of ore to avoid overloading or underloading the mill, (b) adjusting the speed to ensure efficient grinding and material movement, and (c) optimizing the transport of material through the mill for better processing.

For example, FIGS. 9-11 illustrate varying conditions inside the drum. By reading the strain/rotation graphs of FIGS. 6-9, a mill operator could evaluate the conditions inside the drum and make adjustments based on what might be the desired condition for that site.

Once the optimization graph has been created, the mill can be optimized in one or more of the following ways:
Adjust ore charging rate: Increase or decrease the ore charging rate to achieve the desired load level and distribution within the drum.
Adjust drum rotational speed: Increase or decrease the drum's rotational speed to influence the ore's movement and impact within the drum.
Adjust Water: Add or reduce water inside the drum to create a thinner or thicker slurry, impacting the ore's flow and crushing characteristics.

### Other Operational or Controlled Parameters.

It is also possible to implement machine learning to analyze the data. In this way machine learning can implement algorithms to analyze data and suggest optimal operating parameters automatically.

While the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention. The detailed description herein is presented for purposes of illustration only and not of limitation.

What is claimed is:

1. A system for optimizing a rotating mill, the system comprising:
a rotatable drum,
a strain gauge mounted on an outer surface of the drum,
a means for determining angular position of the drum,
a data logger connected to the strain gauge and means for determining angular position of the drum,
a processor and a memory, the processor and memory operatively coupled to the data logger, the processor and memory configured to receive data from the strain gauge and the means for determining angular position and analyze said data to determine at least one operational parameter of the rotating mill.

2. The system of claim 1, the means for determining angular position of the drum is an accelerometer.

3. The system of claim 1, further comprising the placement of a plurality of strain gauges along the axial length of the rotatable drum.

4. The system of claim 1, wherein the at least one operational parameter comprises ore charge level within the drum.

5. The system of claim 1, further comprising the orientation of at least one strain gauge in an equatorial direction.

6. A rotating mill comprising:
a rotatable drum,
a strain gauge mounted on an outer surface of the drum,
an accelerometer mounted on the outer surface of the drum, and
a data logger connected to the strain gauge and accelerometer, the data logger configured to collect data therefrom, and
a processor configured to receive and analyze said collected data.

7. The rotating mill of claim 6, wherein the data logger further comprises a wireless transmitter.

8. The rotating mill of claim 6, wherein the accelerometer is a DC accelerometer capable of measuring both static and dynamic acceleration.

9. The rotating mill of claim 6, wherein the strain gauge is a rosette-type strain gauge.

10. The rotating mill of claim 6, further comprising a plurality of strain gauges mounted on the outer surface of the drum along an axial length thereof.

11. The rotating mill of claim 6, the processor creating an axial map of charge level/load distribution.

12. The rotating mill of claim 6, the processor determines the ore detachment point.

13. A method for optimizing the operation of a rotating mill, comprising:
measuring strain on an outer surface of a rotating drum,
measuring acceleration on the outer surface of the drum,
analyzing the strain and acceleration data to determine at least one operational parameter of the rotating mill, the at least one operational parameter comprising the level of ore charge within the drum; and
adjusting at least one operational input of the rotating mill based on the analysis.

14. The method of claim 13 wherein adjusting comprises adjusting ore charge rate.

15. The method of claim 13 wherein adjusting comprises adjusting drum rotational speed.

16. The method of claim 13 wherein adjusting comprises adjusting water level.
